(19) United States
(12) Patent Application Publication
(10) Pub. No.: US 2018/0324172 A1
(43) Pub. Date: Nov. 8, 2018

(54) SINGLE SIGN-ON FOR REMOTE APPLICATIONS

(71) Applicants: Mahesh Unnikrishnan, Redmond, WA (US); Samuel Devasashayam, Kirkland, WA (US); Arun Nanda, Sammamish, WA (US)

(72) Inventors: Mahesh Unnikrishnan, Redmond, WA (US); Samuel Devasashayam, Kirkland, WA (US); Arun Nanda, Sammamish, WA (US)

(21) Appl. No.: 14/611,275

(22) Filed: Feb. 1, 2015

(51) Int. Cl. H04L 29/06; H04L 9/32

(52) U.S. Cl. CPC H04L 63/0815; H04L 63/0823; H04L 63/102; H04L 9/3213

(57) ABSTRACT

The present disclosure is directed to a method and system for obtaining or allowing single sign-on capability for remote applications. The system receives a request a user device to register with a remote application or desktop service. The system then authenticates the user with the service, by receiving the user's credentials, and generating an access token and a single sign-on token. The user is presented with a list of remote applications that can be accessed through the service. The system receives the indication of the selection by the user and then proceeds to authenticate the user with the remote application. The remote application connects with the authentication service and presents the tokens that were generated in a certificate request to the authentication service. The authentication service uses this request and obtains a certificate authority a logon certificate that is used to log the user into the remote application.

### BACKGROUND

Services are often provided that offer remote access to an end-user's desktop hosted in a virtual machine either on-premises or in the cloud. These services can be secured by an authorization service in order to benefit from conditional access control. Conditional access control provides administrators the ability to require compliance with access control policies such as the need to perform multiple-factor authentication, use compliant devices etc. in order to access secured resources.

For these remote desktop/application services the authorization service provides the client with an access token containing claims, if the user is authorized to access the remote desktop/application. However, such access tokens cannot be used to log the user interactively to the domain in order for users to access other domain resources such as file shares etc. Currently, remote desktop/application services need to present an additional credential collection experience in order to obtain user credentials to log the user to the domain interactively. This requires the user to enter their credentials multiple times in order to access their remote desktop or remote applications. Additionally, this requirement also causes raw user credentials (like passwords) to be exposed and stored in various parts of the system, without the ability to control the lifetime of that exposure/storage.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a method and system for obtaining or allowing single sign-on capability for remote applications that do not share information with one another or otherwise would not be able to use single sign on systems. The system receives a request from an application on a user device to register with a remote application or desktop service. The system then authenticates the user with the service, by receiving the user's credentials. This is provided to an authentication service that authenticates the user to access the service. It also provides a single sign-on token back to the application on the user's device such that the service and the application know that the capability has been activated. The user is presented with a list of remote applications that can be accessed through the service. The user selects one of these applications. The system receives the indication of the selection by the user and then proceeds to authenticate the user with the remote application. The remote application connects with the authentication service and presents the tokens that were generated in a certificate request to the authentication service. The authentication service uses this request and obtains either from its self or certificate authority a logon certificate that is used to log the user into the remote application. Each time the user changes the application the original credentials are presented by the service to the authentication service to obtain a new logon certificate for the user without further input from the user

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating the components of a system 100 that provides for a single sign-on experience for remote applications according to one illustrative embodiment.

FIG. 2 is a screen capture illustrating a version of the application according to one illustrative embodiment.

FIG. 3 is a flow diagram illustrating a process for obtaining a single sign on certificate according to one illustrative embodiment.

FIG. 4 is a flow diagram illustrating the process for authorizing the application to access the service and validating the user according to one illustrative embodiment.

FIG. 5 is a flow diagram illustrating the process of connecting to a remote application according to one illustrative embodiment.

FIG. 6 is flow diagram illustrating the process of obtaining a logon certificate according to one illustrative embodiment.

FIG. 7 illustrates a component diagram of a computing device according to one embodiment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media or computer readable storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media, but not computer storage media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

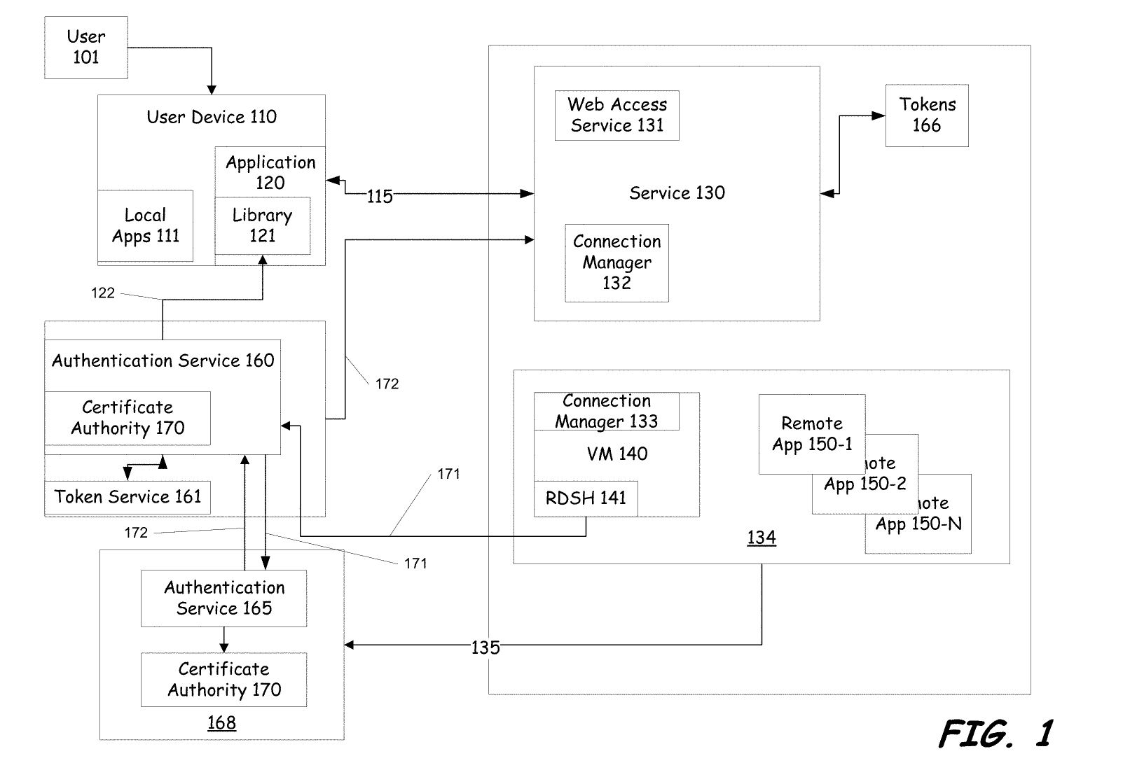

FIG. 1 is a block diagram illustrating the components of a system 100 that provides for a single sign-on experience for remote applications where the remote applications require authentication of the user prior to providing the user with access to the remote application. System 100 includes a user device 110, a service 130, at least one virtual machine 140, a number of remote applications 150-1, 150-2, 150-N (collectively remote application or applications 150), an authentication service 160 and a certificate authority 170. For purposes of this discussion the various components that are part of the service 100 may be referred to by component names provided by Microsoft Corporation of Redmond Wash. in providing a cloud or distributed computing services, security and management. While these components may be referred to by their trade names herein, those skilled in the art will readily recognize that these components can be switched with components developed or provided by other manufacturers when arranged, configured or modified according to the present disclosure can be substituted for the components of the system to provide similar results.

User device 110 is any device that a user uses to connect to the service 130. User device 110 can be for example, a personal computer, a tablet computer, a mobile phone, a desktop computer, a laptop computer, etc. Further, the user device 110 can be a virtualized version of these devices. The user device 110 may also include a number of local applications 111. Local applications 111 are applications that reside on the user device 110 from which the user can directly access the applications without the need to go through a network, such as network 115. The user device 110 also has the ability to access remote applications such as remote applications 150 through the network 115. Network 115 can be any type of network through which two machines can connect with each other and communication, such as an internet, an intranet, virtual private networks, telecommunications networks, cellular networks, wireless networks, etc.

User device 110 also includes an application 120 that permits the user to connect to the service via the network 115. The application 120 is in one embodiment a rich client application that capable of operating on multiple different platforms such as Windows, iOS, Android, Mac OS X, etc. This allows the user to have access to the service 130 regardless of the specific type of device the user has. The application 120 is configured to display to the user the remote applications 150 that have been published by the organization through the service for consumption by the user 101. The application 120 is configured to prompt the user when they first connect to the service 130 for their credentials and allows the user to be validated throughout the system. After entering their credentials here the user does not enter their credentials again to access any of the remote applications 150. Further, the application 120 does not transmit over the network any further credentials or validation of the user when the user moves between different remote applications 150. The application 120 once authorized to access the service 130 is configured to retrieve or fetch a list of the remote applications that have been published for the user.

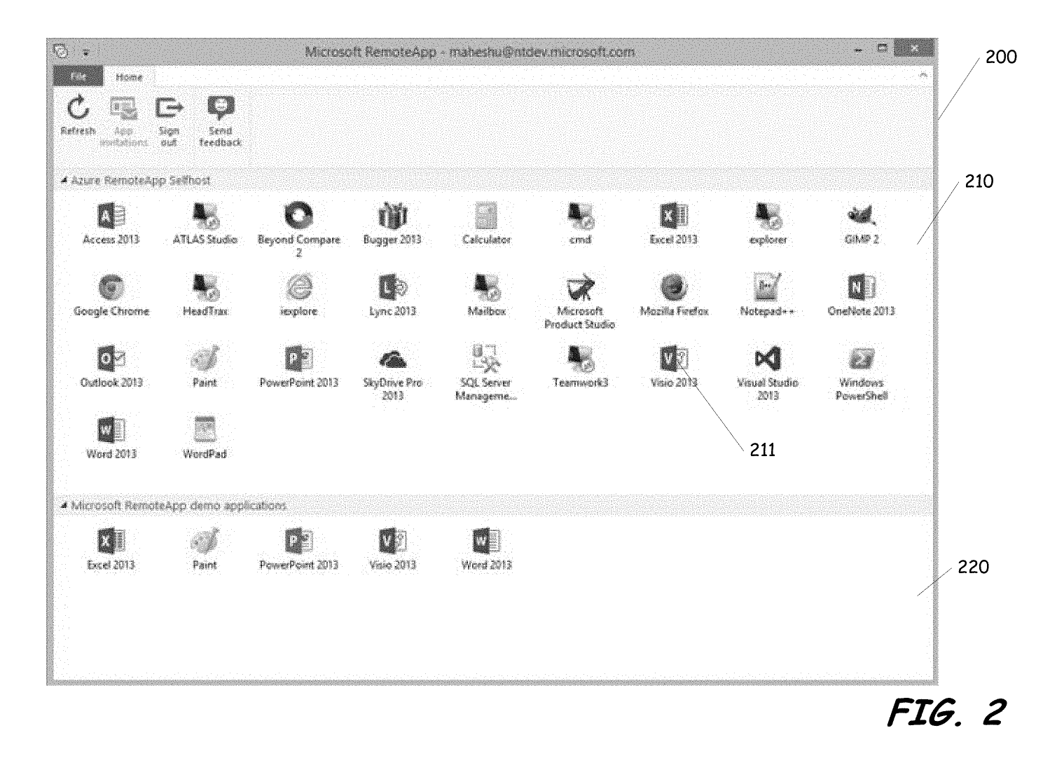

FIG. 2 is a screen capture illustrating a version of the application presented in the Windows operating system. Other platforms and operating systems would have a similar looking display that is formatted according to the formatting of the particular platform or operating system. In FIG. 2, the applications listed in the screen capture 200 of the application 120 are files that enable the user 101 to connect remotely to the corresponding application running on a virtual machine such as virtual machine 140 managed by the service 130. The applications illustrated in the screen capture 200 may be divided into multiple sections or areas. Area 210 shows applications that the administrator has made available to the user for access. In some embodiments area 210 may show applications that the user does not have access to, but are part of the general corporate environment. These applications may be shown as greyed out or otherwise unavailable to the user. Area 220 shows applications that may be available from the service that are either not part of the user's corporate applications but are provided by the service 130 to the public in general, or can be applications that the user 101 has placed on the service 130 from outside of the corporate environment. This allows the user to blend their personal remote applications with corporate remote applications on the same device 110 while permitting the appropriate levels of security and access control to be applied to each remote application.

The user selects an application from the list of applications in area 210. For example the user may click on the application 211. However other approaches of selecting the application may be used. As a result of the selection of the application 211, the application 211 attempts to connect to the virtual machine hosting the remote application 150. In contrast to previous systems the user is not prompted to provide the credentials a second time.

Returning back to FIG. 1 service 130 is in one embodiment a remote desktop service that allows the user to remotely access resources (machines, applications, devices, etc.) that are not part of the user's actual device as if that resource was a native resource of the user device 110. Service 130 further hosts one or more virtual machines that contain the remote applications 150. Further the service 130 is configured to authenticate the user with the appropriate authentication service 160 and store in the service 130 access and refresh tokens 166 for each validated or authenticated user. In some embodiments the service 130 is operated on a per tenant basis. That is there is one version of the service 130 for each tenant (organization) that uses the service 130. In other embodiments the service 130 is multi-tenant. That is more than one organization shares or uses one version of the service 130. Service 130 in one embodiment is consists of a web access service 131, such as Microsoft Corporation's Remote Desktop Web Access, that permits the user to access and connect to the remote applications 150, and a connection manager 132, such as Microsoft Corporation's Remote Desktop Connection manager, that handles the core connection management and brokering capabilities. Generally the web access service 131 and the connection manger 132 are operated in a multi-tenant manner within the service 130 even when portions of the service 130 are operated in a per-tenant basis. However, as illustrated in FIG. 1 a per-tenant connection manager 133 and virtual machines 140 for the organization are isolated within a virtual network 134 for the organization. This provides isolation between tenants in the cloud. Additionally, the virtual network 134 may also configured with connectivity to the customer's on-premises infrastructure via an IPSEC tunnel or other secure channel 135, so that virtual machine 140s running in the virtual network can reach the organization's authentication service 165 such as Active Directory as well as any other on-premises services that the remote applications 150 may rely on. However, as mentioned above the connection manager 133 is optional.

When the user launches an application, such as application 211, that has been published for their use the service 130 uses either an existing virtual machine 140 to run the selected application or spins up a new instance of the virtual machine 140, if required. The service 130 is also configured to join, if necessary, these virtual machines 140 to a domain associated with the organization. The user is then logged in to that virtual machine 140 and connected to the corresponding remote application 150 they desire to use.

Virtual machines 140 are virtualized versions of physical computing devices that contain the remote applications 150. Virtual machines 140 may include a remote desktop shell 141 (RDSH) such as the Remote Desktop Shell from Microsoft Corporation or similar component found on other types of virtual machines. Remote applications 150 are the applications that the organization has decided to publish to the user for consumption by the user. Any application can be presented as a remote application to the user so long as the organization has decided to publish the application.

Authentication service 160 is a component of the system 100 that authenticates the user to both access the service 130 and the applications 150. In one embodiment the authentication service 160 interacts with a security token service 161 that issues access tokens and refresh tokens to the application 120 and the service 130. The security token service 161 and the authentication service 160 can be in federation with each other. In some embodiments the authentication service 160 is able to authenticate the user on its own. However, in other embodiments the authentication service 160 interacts with a second authentication service 165. This second authentication service 165 may be an authentication service that is located on the premises 168 of the organization that is publishing the remote applications 150. When the user first signs in to the service 130 from their device 110 using the application 120, an authentication library 121 within the application 120 navigates to the authentication service 160. The authentication service 160 authenticates the user and provides the user an access token to access the service 130. If the authentication service uses a second authentication service 165, the authentication service 160 will redirect the user to the second authentication service 165 to authenticate the user. Once authenticated by the authentication service 165 the authentication service 160 provides the application with the corresponding access and refresh tokens 166.

Certificate authority 170 is a component of the system that issues the certificates 172 needed for the interactive logon of the user in the single sign on environment in response to a request for a certificate 171 from the service 130 through the authentication service 160 or 165. In some embodiments the certificate authority 170 is a component of the authentication service 160. In this embodiment when the authentication service 160 receives a request for a logon certificate 171 the authentication service 160 performs any required validation checks to ensure that certificates can be issued for the specific user. If this is possible the authentication service 160 issues the certificate 172 by signing certificate signing request and returning the logon certificate to the service 130. However, in other embodiments the certificate authority 170 is a separate from the authentication service 160. In this embodiment the authentication service 160 or 165 acts as an enrollment agent or registration authority. In this approach the authentication service 160 has been granted the necessary privileges to request user logon certificates on behalf of the end users. The certificate authority 170 in this embodiment is configured to recognize the authentication service 160 or 165 as an agent capable of issuing the logon certificates. The certificate authority 170 is configured to receive a request that is based on the certificate signing request from the authentication service 160 or 165 that has been signed using the appropriate certificate from the authentication service 160 or 165. The certificate authority 170 then processes the requests by validating this requests and returns a certificate 172 to the authentication service.

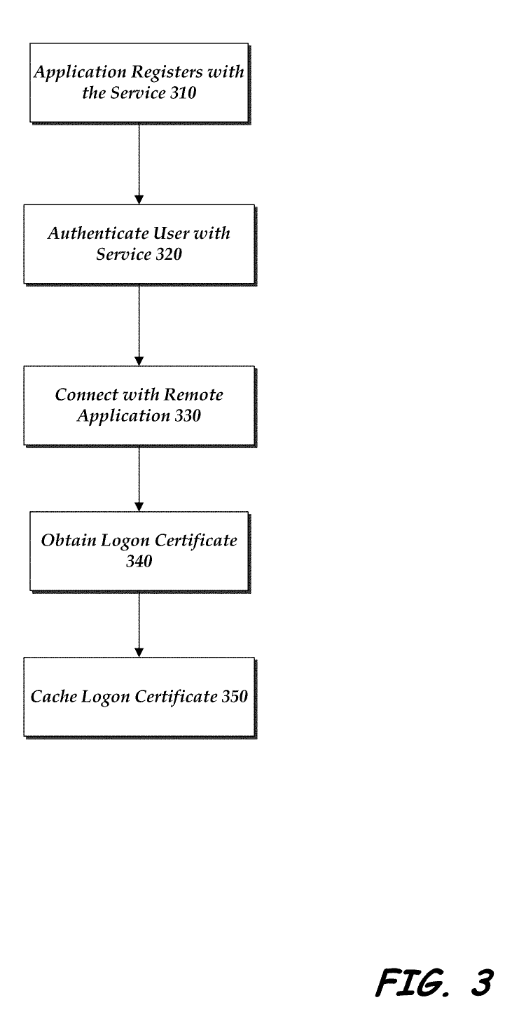

FIG. 3 is a flow diagram illustrating a process for obtaining a single sign on certificate for the service 130 Such that the user can access the remote applications without further entry of credentials. In this illustration an organization is registered for the service 130 such that users can access the remote applications 150 through the application 120 on their devices 110. In this embodiment the organization is presumed to be a federated tenant that has set up identity federation between its subscription to the service 130 and its on-premises authentication service 165. The user's identities are authenticated on-premises by the authentication service 165. However, the organization need not be a federated organization.

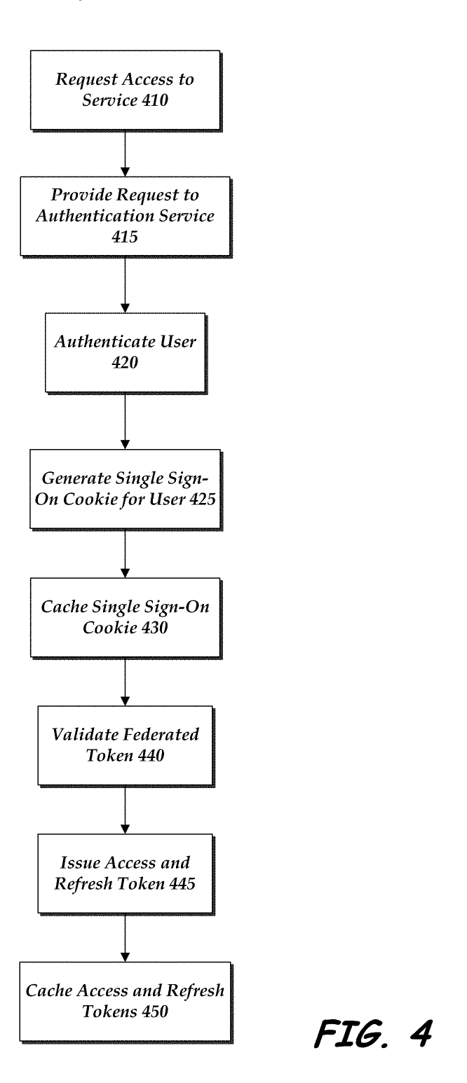

The process of FIG. 3 begins when the application 120 registers with the service 130. This is illustrated at step 310. Next the user is validated and access is granted to the user for the application to the service. This is illustrated at step 320. After the user is validated the user is presented a list of application to select from and connects to the remote applications. This is illustrated at step 330. In order to gain access to the remote application 150 a logon certificate is obtained. This is illustrated at step 340. This logon certificate is cached at the service 130. This is illustrated at step 350. When the user attempts to connect to a different remote application the service 130 presents this logon certificate to the corresponding application for access to the application without further involvement of the user. Alternatively, the process takes the information obtained from the validation step and repeats steps 330-350 to obtain a new logon certificate for the user. FIGS. 4-6 provide more details related to the steps above in FIG. 3.

FIG. 4 is a flow diagram illustrating the process for authorizing the application 120 to access the service and validating the user. The process begins when the application 120, i.e. the native application on the user's device 110, requests access to the service 130. This is illustrated at step 410. As discussed above the service 130 is secured by an authentication service 160 that includes a security token service 161. The security token service 161 is in turn federated with the authentication service 160 and, in this instance, the authentication service 165 associated with the organization. The request from the application 120 to the security token service 161 is for an access token and a refresh token 166.

The security token service 161 redirects the request from the application to the corresponding authentication service 165 associated with the organization. This is illustrated at step 415. The request is received by the authentication service 165 for the organization. The authentication service 165 authenticates the user. This is illustrated at step 420. Next or at the same time a persistent single sign-on token is generated for the user. In some embodiments this may be represented as a single sign-on cookie. This persistent single sign-on token 122 is cached in an authentication library 121 for the application 120. This is illustrated at step 430. Also at this time the authentication service 165 provides a federated access token to the application 120.

Following the authentication of the user by the authentication service 160 or 165, the authentication service 165 redirects the application back to the security token service 161. This is illustrated at step 440. At this step the security token service validates the federated access token. Upon successful validation of the federated access token the security token service 161 issues an access token and refresh token pair to the application 120. This is illustrated at step 445. The authentication library for the application 120 then caches this access token and refresh token pair. This is illustrated at step 450. This pair is then later used by the application in subsequent interactions with the service 130 to provide authorization of the application 120 to access the service 130. However, at this point all that has been authorized is the ability of the application 120 to access the service 130.

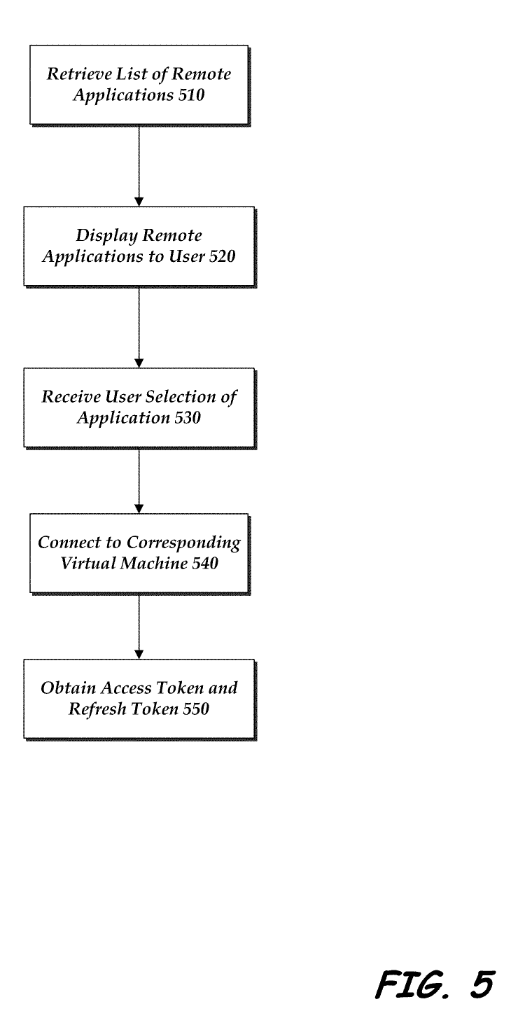

FIG. 5 is a flow diagram illustrating the process of connecting to a remote application 150 on the virtual machine 140. After obtaining access to the service 130 as discussed above with respect to FIG. 4, the application 120 is now able to retrieve a list of remote applications 150 that have been published for use by the user by the organization. This is illustrated at step 510. This list of remote applications 150 is then displayed to the user on their device 110. This is illustrated at step 520. This list of remote applications 150 can be displayed to the user as discussed above with respect to FIG. 2. Again, additional applications may be provided to the user that do not originate with the organization, but the user has access to. When the user selects one of the remote applications 150 available for their use from within the application 120 the application then tries to connect the user to that remote application 150. This is illustrated at step 530. The user will need to be connected to one of the domain-joined virtual machine 140 instances 140 within the organizations virtual network 134 that are managed by the service 130. The remote desktop shell 141 component on the virtual machine 140 is responsible for logging in the user interactively to the virtual machine 140 so they can interact with the remote application 150. This is illustrated at step 540.

In order for the application 120 to connect to the remote desktop shell component 141 on the target virtual machine 140 and request an interactive logon for the user, the application 120 must first obtain an access token for the remote desktop shell 141 that was issued by authentication service 160 or 165. This is illustrated at step 550. Again it should be noted that the remote desktop shell 141 component is on a domain joined machine and will trust access tokens issued by the on-premises authentication service 165 instance of which it is a relying party.

The application 120 uses authentication library 121 to obtain an access token and refresh token 166 from the authentication service instance using an authorization code grant type such as OpenID Connect or other type. The application 120 will request a new certificate that is required in order to exchange a token issued by the authentication service 160 or 165 for an interactive logon certificate. It should be noted that this access token and refresh token is different than the tokens received earlier in that the first access and refresh tokens were for the user and not for the application. The authentication service consumes the persistent single sign on token that was previously issued by the authentication service 160/165 during the process of authenticating the application 120 with the service 130. As the user 101 has already authenticated themselves the application 120 acquires the access and refresh tokens without further prompting the user to provide their credentials. In some embodiments the authentication service 160/165 verifies that the corresponding application permission entry exists for the application on the client device 110 to request a token for the remote desktop shell 141 on behalf of the authenticated user. If the correct permissions exist the authentication service 160/165 will issue the access token and the refresh token to the application. The access token will include information in it, such as a claim, that indicates that the access token can be used to obtain a logon certificate for the authenticated user.

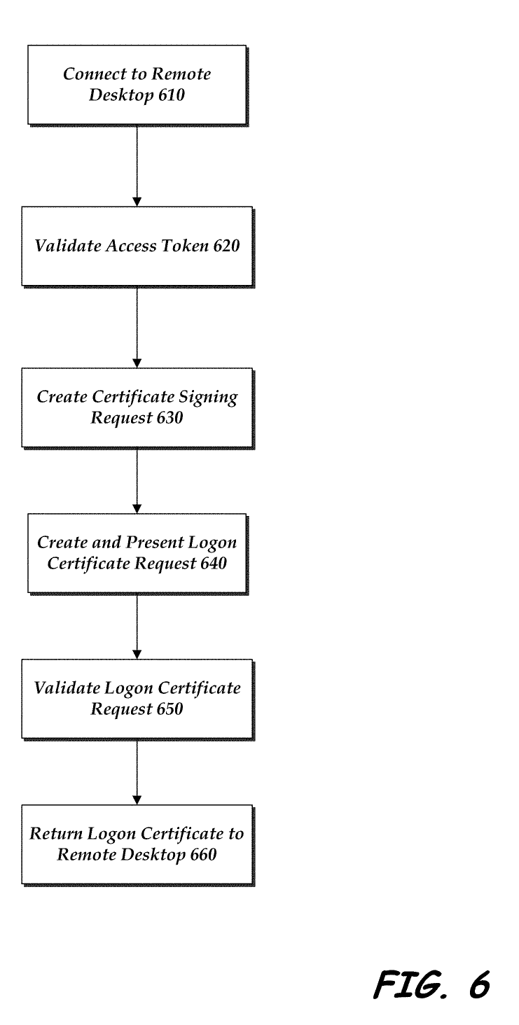

Once the application has obtained the access token from the authentication service such that it can access the remote desktop shell 141, the process proceeds to log the user on to the virtual machine 140. To log the user on to the virtual machine 140 a logon certificate is need by the system. The process of obtaining the logon certificate is illustrated in FIG. 6. The logon certificates 172 can either be issued by the authentication service 160/165 directly or may be issued by another party such as a corporate certificate authority 170 that manages the issuance of certificates to users.

The application 120 connects with the appropriate remote desktop shell 141 instance. This is illustrated at step 610. At this step the application 120 presents the access token that was issued to the application 120 by the authentication service 160/165. The remote desktop shell 141 instance validates the access token. This is illustrated at step 620. At this step the remote desktop shell 141 performs regular token validation checks for the access token. This validation process can include validating the validity of the token, verifying the signature of the token, etc. It should be noted that any validation process on the access token may be performed. The remote desktop shell 141 also checks that the token has the claim that indicates that the access token can be used to obtain the logon certificate.

Once the token has been validated by the remote desktop shell 141, the remote desktop shell 141 constructs a public/private key pair that will be used in a certificate signing request that requests the logon certificate from the authentication service. The remote desktop shell 141 then constructs the certificate signing request. This is illustrated at step 630. This certificate signing request can in one embodiment be in accordance with a protocol such as RFC 2986. However, as long as the certificate signing request is in the format that is expected by the authentication service 160/165 the remote desktop shell 141 can use any format for the request.

Next the remote desktop shell 141 presents to the authentication service 160/165 the logon certificate request 171. This is illustrated at step 640. The logon certificate request includes several attributes. The logon certificate request includes the access token that was presented to it by the application 120. This is the access token that was issued to the application to access the service 130. The logon certificate request also includes a means for authenticating the remote desktop shell 141 with the authentication service 160/165. In one embodiment this means is through an authentication service such as Windows Integrated Authentication. However, other authentication services can be used. Finally the logon certificate request includes the certificate signing request that was generated at step 630.

The authentication service 160/165 then validates the logon certificate request. This is illustrated at step 650. The authentication service check to see if the presented access token is valid, unexpired, signed by the authentication service and contains the claim that the access token can used to obtain the logon certificate. As part of the validation of the request the authentication service 160/165 performs its own authentication of the remote desktop shell 141 using the same authentication service as the remote desktop shell 141 used to authenticate itself to the authentication service.

Once the authentication of the remote desktop shell 141 has been completed and the logon certificate request has been validated a logon certificate for the user is returned to the remote desktop shell 141. This is illustrated at step 660. This logon certificate is then used by the remote desktop shell 141 to log the user onto the applications that are hosted by the virtual machine 140. In this way the user is able to move between applications without having to constantly reenter their credentials. In embodiments where the authentication service does not issue the logon certificate the authentication service constructs and sends a certificate request to the certificate authority 170. Once the authentication service receives the logon certificate back from the certificate authority 170 it forwards this certificate to the remote desktop shell 141. Otherwise the authentication service generates the logon certificate itself and returns this to the remote desktop shell 141. When the user moves to a different remote application 150 at a later time the system 100 repeats the above processes to obtain a new logon certificate for the user based on the original access token to the service 130.

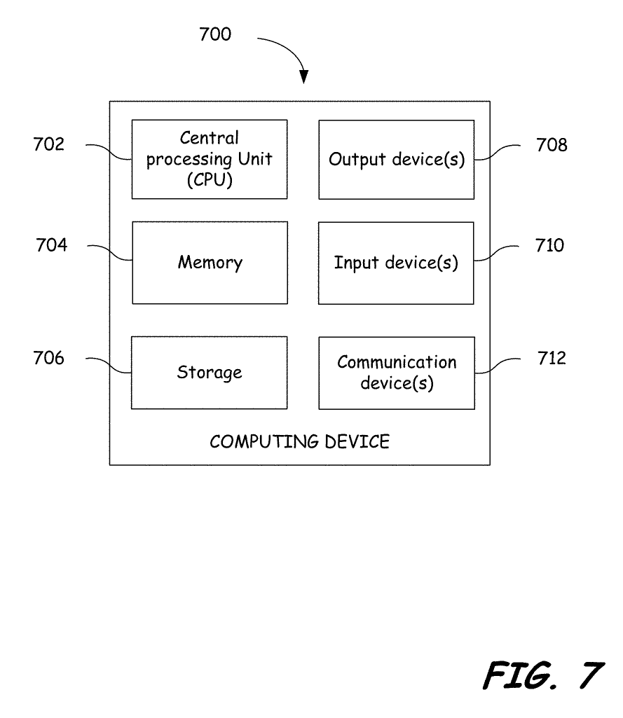

FIG. 7 illustrates a component diagram of a computing device according to one embodiment. The computing device 700 can be utilized to implement one or more computing devices, computer processes, or software modules described herein. In one example, the computing device 700 can be utilized to process calculations, execute instructions, receive and transmit digital signals. In another example, the computing device 700 can be utilized to process calculations, execute instructions, receive and transmit digital signals, receive and transmit search queries, and hypertext, compile computer code, as required by the system of the present embodiments. Further, computing device 700 can be a distributed computing device where components of computing device 700 are located on different computing devices that are connected to each other through network or other forms of connections. Additionally, computing device 700 can be a cloud based computing device.

The computing device 700 can be any general or special purpose computer now known or to become known capable of performing the steps and/or performing the functions described herein, either in software, hardware, firmware, or a combination thereof.

In its most basic configuration, computing device 700 typically includes at least one central processing unit (CPU) 702 and memory 704. Depending on the exact configuration and type of computing device, memory 704 may be volatile (such as RAM), non-volatile (such as ROM, flash memory, etc.) or some combination of the two. Additionally, computing device 700 may also have additional features/functionality. For example, computing device 700 may include multiple CPU's. The described methods may be executed in any manner by any processing unit in computing device 700. For example, the described process may be executed by both multiple CPU's in parallel.

Computing device 700 may also include additional storage (removable and/or non-removable) including, but not limited to, magnetic or optical disks or tape. Such additional storage is illustrated in FIG. 7 by storage 706. Computer storage media includes volatile and nonvolatile, removable and non-removable media implemented in any method or technology for storage of information such as computer readable instructions, data structures, program modules or other data. Memory 704 and storage 706 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 700. Any such computer storage media may be part of computing device 700.

Computing device 700 may also contain communications device(s) 712 that allow the device to communicate with other devices. Communications device(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 700 may also have input device(s) 710 such as keyboard, mouse, pen, voice input device, touch input device, etc. Output device(s) 708 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

In summary the present disclosure is provides a method and system for obtaining or allowing single sign-on capability for remote applications that do not share information with one another. The system receives a request from an application on a user device to register with a remote application or desktop service. The system then authenticates the user with the service, by receiving the user's credentials. This is provided to an authentication service that authenticates the user to access the service. It also provides a single sign-on token back to the application on the user's device such that the service and the application know that the capability has been activated. The user is presented with a list of remote applications that can be accessed through the service. The user selects one of these applications. The system receives the indication of the selection by the user and then proceeds to authenticate the user with the remote application. The remote application connects with the authentication service and presents the tokens that were generated in a certificate request to the authentication service. The authentication service uses this request and obtains either from its self or certificate authority a logon certificate that is used to log the user into the remote application. Each time the user changes the application the original credentials are presented by the service to the authentication service to obtain a new logon certificate for the user without further input from the user.

1. A method for obtaining single sign-on capability for at least two remote applications, the method comprising:
receiving a request to register an access application on a user device with a remote application service on a remote device;
authenticating a user of the access application with the service;
receiving an indication of a selection of a remote application by the user;
authenticating the user with the selected remote application based upon the authentication of the user with the service and without requesting additional credentials from the user a second time; and
granting access to the user to access the remote application.

2. The method of claim 1 wherein one of the at least two remote applications is on a different virtual machine than another of the at least two remote applications.

3. The method of claim 1 wherein authenticating the user with the access application further comprises, generating a single sign-on token for the user.

4. The method of claim 1 wherein authenticating the user with the access application further comprises:
issuing an access token and a refresh token for the access application to access the remote application service.

5. The method of claim 1 wherein authentication the user with the selected remote application further comprises:
connecting to a remote desktop hosting the selected remote application; and
authenticating the user with the selected remote application based upon an access token associated with the authentication of the user with the remote application service.

6. The method of claim 5 further comprising:
validating the access token.

7. The method of claim 5 further comprising:
creating a certificate signing request.

8. The method of claim 5 further comprising:
creating a logon certificate request;
validating the logon certificate request; and
returning a logon certificate to the remote desktop.

9. The method of claim 8 wherein validating the logon certificate is performed by a certificate authority separate from an authentication service.

10. The method of claim 8 wherein validating the logon certificate is performed by an authentication service.

11. The method of claim 1 further comprising:
receiving an indication of a selection of a second remote application from the user;
authenticating the user with the second remote application based without requesting additional credentials from the user; and
granting access to the user to access the second remote application following successful authentication of the user.

12. A system for permitting a single sign on experience to at least two remote applications comprising:
at least two remote applications, the at least two remote applications requiring that a user is authenticated to access the application prior to granting the user access to the application;
an authentication service configured to authenticate the user to access the at least two remote applications and further configured to authenticate the user to access a remote application service; and
the remote application service hosting the at least two remote applications, the remote application service configured to receive credentials from a user to access the service and to receive from the authentication service at least one token indicating that the user is authorized to access the service, and further configured to use the at least one token to authenticate the user to use one of the at least two remote applications.

13. The system of claim 12 further comprising:
a user device configured to connect with the remote application service through an application on the user device, the application configured to display to the user an interface that that the user can select at least one of the at least two remote applications.

14. The system of claim 12 further comprising:
a certificate authority configured to provide a logon certificate to the authentication service in response to a certificate request from the authentication service when the certificate request can be validated by the certificate authority.

15. The system of claim 14 wherein the certificate authority is a component of the authentication service.

16. The system of claim 12 wherein the authentication service further comprises:
a security token service, configured to issue access and refresh tokens for the user upon validation of the user.

17. The system of claim 16 wherein the security token service is further configured to redirect the user to a second authentication service, and to receive from the second authentication service an indication that the user has been authenticated.

18. The system of claim 17 wherein the second authentication service is an authentication service controlled by an organization different from an organization controlling the authentication service.

19. The system of claim 12 wherein the remote application service is configured to receive from the user an indication of a selection of a different remote application and further configured to request a logon certificate from the authentication service for the different remote application without receiving additional input from the user.

20. A computer readable storage medium having computer executable instructions that when executed by at least one computer having at least one processor causes the computer to:
register an application disposed on a user device with a remote application service;
authenticate the user with the remote application service by providing from the remote application service user supplied credentials to an authentication service and receiving from the authentication service an access token granting the user access to the remote application service;
connect the user with a remote application hosted by a remote desktop on the remote application service;
authenticate the user to access the remote application by providing a request for a logon certificate to a credential authority wherein the request is based upon the access token received when authenticating the user to the service;
receive a logon certificate from the credential authority; and
log the user on to the remote application using the logon certificate.
